(19) United States
(12) Patent Application Publication
(10) Pub. No.: US 2021/0241326 A1
(43) Pub. Date: Aug. 5, 2021

(54) APPARATUS AND METHOD FOR DELIVERY OF CROWDFUNDED SERVICES AND GOODS

(71) Applicant: BIGDATA TEKNOLOJI A.S., Beykoz Istanbul (TR)

(72) Inventors: ADNAN BAYSAL, ISTANBUL (TR); SEYHAN CIVANLAR, ISTANBUL (TR); EROZAN KURTAS, ISTANBUL (TR)

(21) Appl. No.: 17/167,061

(22) Filed: Feb. 3, 2021

Related U.S. Application Data
(60) Provisional application No. 62/995,529, filed on Feb. 3, 2020.

(51) Int. Cl. G06Q 30/02; G06Q 20/38; G06Q 30/08; G06Q 20/06; G06Q 10/10; G06Q 30/06; G06Q 30/00

(52) U.S. Cl. CPC G06Q 30/0279; G06Q 20/389; G06Q 30/08; G06Q 20/0655; G06Q 30/0609; G06Q 30/0605; G06Q 30/0185; G06Q 2230/00; G06Q 2220/00; G06Q 10/10

(57) ABSTRACT

A crowdfunding setup for directly supplying services/goods to beneficiaries. The actors are: (i) a plurality of funders, who are able to track where and how their funds are put into use, (ii) a plurality of beneficiaries, who have access to funds only for a specific need of a service or good as opposed to money, (iii) a plurality of service/goods providers, who meet a set of criteria to supply the needed service or good to the beneficiaries, and (iv) a campaign controller, who sets up the campaign that ties together all actors and their actions. Selection of the service provider is based on a plurality of criteria for each campaign where such a selection is based on a combination of actors using a consensus mechanism. Upon collection of funds, the beneficiary is provided the service/good, which is also tracked by the campaign and the funders.

### RELATED APPLICATION

This application claims the benefit of provisional application 62/995,529 filed Feb. 3, 2020.

### BACKGROUND OF THE INVENTION

### Field of Invention

The present invention in general relates to crowdfunding services and goods. A database application, a web portal, a blockchain, a distributed ledger, a set of smart contracts, and their embodiments are for the use of ensuring the transparency and automatic to execution of supplying the need of a beneficiary.

### Discussion of Related Art

Any discussion of the prior art throughout the specification should in no way be considered as an admission that such prior art is widely known or forms part of common general knowledge in the field.

Crowdfunding is a new mechanism to provide funds from people for a target goal when the beneficiary doesn't have enough funds to accomplish that goal. It emerged as an alternative approach to raising funds from institutionalized funders such as banks and venture investment companies. Generally, a campaign is initiated for a specific project with a goal pledge amount. Donation campaigns of a charity or NGO (Non-Governmental Organization), an IPO (Initial Public Offering) of a company, or tax collection can be considered as different forms of crowdfunding.

The beneficiary publishes information for her/his company or project to initialize crowdfunding, and then announces the need for crowdfunding with a target amount (usually on a website). Individuals who want to contribute to the project donate, and in return, the project owner usually provides a reward. For example, www.kickstarter.com is an excellent example portal for initiating and conducting a crowdfunded project. Usually, funders fund the project with an amount that they decide as opposed to campaign-specified amounts. The reward for the funder can be a share of the company, a good, or a service of the company/project, or simply social recognition.

Many crowdfunding applications are highly vulnerable to forgery. For example, in a donation campaign, a beneficiary may use the collected money for another need since there is no traceability of usage. The entrepreneur may run away after taking the money in the fund pool. In fact, the charity or NGO that coordinates the funding may also be involved in the scheme. The charity may transfer only a small portion of the collected funds and keep the rest. In the government case, the non-traceability of usage of collected taxes is one of the reasons for corruption. These problems are mainly due to the collected funds being given to beneficiaries in the form of money, and the inability of funders to track the usage of their contributions.

In order to overcome the stated shortcomings and according to an aspect of this invention, the crowdfunding is modeled as a set of services and goods to be provided to the beneficiary—as opposed to directly providing money. It works as follows: the campaign gathers funds to go to a selected service provider, and then the service provider provides the service or goods to the beneficiary. Upon completion, the beneficiaries inform the campaign, for the release of funds to the service provider. The problem becomes the selection of the service provider(s) amongst a plurality of service providers who opts in to provide the service. The selection is based on a plurality of criteria that is determined according to each service or good sector. Some criteria may be more important than the others. Such prioritization is jointly determined by the funders, the beneficiaries, and possibly the controller entity, who creates the campaign. In what follows, the term ‘service provider’ is used to generally cover both service and good providers.

Transparency during all stages of crowdfunding is necessary for providing and maintaining the trust in the controlling entity (such as the NGO, government, crowdfunding coordinator, etc.) that is hard to acquire, but easy to lose by a scandal. In fact, preventing fraud is related to trust and transparency. When funders distrust the controller entities, they simply try to avoid funding. In summary, trust is the most important factor for the success of crowdfunding campaigns whether it is a voluntary (donation campaign) or a mandatory (taxation) campaign.

In this invention, we created a new system for the aforementioned actors (funders, beneficiaries, service providers, and possibly a controlling entity) (i) to establish and initiate a campaign, (ii) to conduct the campaign by recording the transactions between the actors at all stages of the campaign until completion, and (iii) to make these transactions visible to all actors.

In this invention, we created a new set of methods:
(i) to specify the most important ‘criteria’ for selecting a service provider (price, timeliness, locality, size, experience, reputation, quality, safety, etc.), wherein the criteria depend on the sector of the service provider (healthcare, education, finance, food, retail, communications, banking, etc.),
(ii) to select a ‘consensus’ method for decision making (by voting, by committee, by hierarchy, reverse auction, etc.) in selecting the best service provider from a plurality of service providers that declare interest in servicing the beneficiaries,
(iii) to track the steps of the delivery of service directly to the beneficiaries, so-called ‘transactions’, and
(iv) to release funds that were reserved for the chosen service provider only when the task is successfully completed.

All these methods are tied using a campaign. What criteria to use for the service provider's sector, what consensus method to choose from possible methods, and which transactions to record are the variables of the campaign design. The system of the present invention is reliant on database technology and several software components including a user interface, wherein use of a blockchain is a possibility for anonymity and transparency. Access to the said system is convenient through a simple web or downloadable application.

There are many applications of the method and system of the present invention. One possible application is crowdfunding of a startup company for a specific good or service that is highly expensive such as a nanotechnology microscope or a special MRI machine, or a specific consulting service. Another possible application is an aid campaign during a natural disaster. Donors who contribute goods or money currently do not know if their contributions reach the survivors (a donation campaign of a charity is similar). Yet another possible application is tax collection wherein taxpayers make direct decisions on their tax money distribution to certain services and goods. Currently, the governments and municipalities decide on where, when and how to spend the tax money and who to contract to provide these services. Many tax payers are against wars, but unfortunately a great amount of tax money goes to funding wars. The concept of campaigns wherein the taxpayers decide where their tax money (or at least some portions of it) goes is enabled by the concepts of this patent application.

Binance is a company, whose main product is a crypto currency exchange, but also has a charity foundation called “Binance Charity Foundation” (BCF, www.binance.charity). In their solution, donors send their donations through Bitcoin blockchain. Donations are directly sent as Bitcoin to the wallets of the beneficiaries after verifying them with digital IDs. While Binance uses blockchain and provides campaign coordination, it suffers from the same shortcomings of the traditional model of crowdfunding.

OpenLedger has a charity solution framework using blockchain, where suppliers are integrated into the donation system. Donors can see the journey of their donations transparently, until the beneficiary gets the service/good they need. However, there is neither support for a service provider selection criteria from a plurality of candidates in their solution framework, nor a consensus mechanism.

World Food Program (WFP) is another blockchain-based project successfully managed to date (see https://innovation.wfp.org/project/building-blocks). In this project, a pilot application is pursued in Jordan, targeting Syrian refugees living in camps. Donations collected by WFP are distributed to beneficiaries using a blockchain system. Since carrying cash is dangerous in those camps, refugees proved their identities with iris scan which led to digital ID verification in order to buy food from a local grocery. Payment to local groceries is accomplished using traditional financial institutions such as banks. Although this system uses blockchain for the donation campaign to collect funds, the system doesn't cater complete transparency.

The WIPO patent application WO 2015/077689 A1 focuses on matching user aspirational savings with their goals, over a social networking system. Their system provides methods for matching user needs and providers. User needs can be crowdfunded, and service providers can join a reverse auction for getting the best price for a goal. The application neither suggests a consensus mechanism for selecting the service provider from a plurality of consensus methods nor a plurality of criteria for service provider evaluation.

US patent application 2014/0025473 focuses narrowly only on the completion of actions related to a crowdfunding, and the corresponding value transfer. Actions are defined as purchases of services or goods related to the crowdfunding project's goal. This patent application, again, does not support a plurality of service providers and the consensus mechanisms.

According to the first aspect of this invention, a beneficiary (or group of beneficiaries) registers into the system of the present invention with a specific need. Exemplary needs are giving an expensive therapy for a cancer patient, providing an electrical wheelchair for a physically immobile person, buying school supplies for poor students, or planting a thousand trees to a barren land, etc. The registry outlines the beneficiaries, the required service or good and approximate funding level required to obtain the service by forming a ‘campaign’. The system of the present invention provides all the tools required to form the campaign. Anyone who has access to the system of the present invention can request to form a campaign or view an existing campaign. Furthermore, the campaign formation includes outlining the services or goods and the associated key ‘criteria’ for selection of the provider depending on the service sector (health-care, technology, construction, etc.). These criteria can be listed from a set of preconfigured criteria, or completely or partially customized for the campaign. Furthermore, the entities collectively deciding on the service provider selection can be customized as well from a combination of the actors, i.e., the controller entity (if any), the funders and the beneficiaries. A deadline is given for the funders to fund the campaign, and the service providers to bid. In one possible embodiment, shortly after the deadline expires and the funds are collected, the service provider is selected using the consensus method and criteria determined at the beginning of the campaign.

In one embodiment, the service provider is selected from a plurality of candidates before the funding process starts so that the funders know the exact cost of the service/good. This embodiment relies on the beneficiaries and controller entity to select the service provider since the funders are unknown at the selection stage.

In a second embodiment, the service provider is selected from a plurality of candidates after the funding process is completed. This embodiment allows the funders to participate or conduct in the service provider selection.

In a third embodiment, a controller entity is not used, i.e., the system works in a totally self-governing workflow without requiring a controller. This embodiment relies on a blockchain for full transparency and trust. In this embodiment, the beneficiary generates the campaign and sets the service provider criteria.

In a fourth embodiment, as part of the campaign, one (or a few) funder amongst all the funders is selected to win a prize. The winner is either selected using a lottery, or simply by selecting the funder with the highest donation. Because the prize is tied to winning, there is more motivation to donate higher amounts.

In all four embodiments above, actual funding can be performed using traditional currencies or crypto currencies. The usage of native crypto-coins such as BTC and ETH, or crypto-tokens such as ERC20 and ERC721 or custom stable and/or non-stable crypto-tokens are viable options.

The consensus method is also determined by any combination of the controlling entity, the beneficiaries, and the funders, which can be selected while creating the campaign according to the above embodiments. Many consensus options are provided in the system of the present invention, from which the campaign chooses one. A few exemplary methods (not exhaustive) are as follows:
a. Voting: Majority of all votes (51%) determines the outcome.
   i. ‘One person one vote’ method: Each participant has only one vote.
   ii. Linear method: Each funder has number of votes ‘linearly’ proportional to his/her funding. Each beneficiary has one vote.
   iii. Quadratic method: Each funder has number of votes proportional to ‘quadratic root’ of his/her funding. Each beneficiary has one vote.
   iv. Voice Credits: Each funder can buy ‘voice credits’ by providing more funding to increase his/her number of votes.
   v. Consensus by all participants: All participants vote.
   vi. Consensus by a random group: A random group selected from all funders and/or beneficiaries votes.
   vii. Consensus by a committee comprised of those funders that contribute the highest amount of funds.
b. Reverse Auction: The least expensive offer from service providers wins the deal.
c. Weighted criteria:
   i. Each criterion for service provider selection is given a weight. The offer with the highest cumulative weight wins.
   ii. Highest weight criteria determine. Each criterion is given a weight. The offer with highest score in the highest weight criteria wins. Reverse auction is a subset of this criteria.

The system of the present invention relies on a centralized or distributed system that comprises a software application designed to implement the methods of this invention, various databases and user interfaces. One possible implementation of the system of the present invention is by using a centralized relational database system. Another possible implementation is by using a distributed blockchain as well as a centralized relational database system. The blockchain database, which is a distributed ledger, records all transactions (digital actions) between funders, service providers and beneficiaries. Furthermore, a digital identification generation and verification system can be incorporated into the implementation for the anonymity of the real identities of actors. Real identities are replaced with trusted digital identities that appear on all transactions. Digital identification generation and verification methods and systems are prior art, and hence will not be recited here.

Blockchain is a distributed peer-to-peer network of nodes wherein each node has a copy of the ledger. Each new block that contains a set of transactions is distributed to every node. The type of information specifically stored in a transaction is up to the application using blockchain. A group of pending transactions (i.e., not grouped and written into the ledger) is validated by one or more nodes in parallel through a process called proof of work (PoW) [see paper to A. Gervals, et. al. entitled, ‘On the Security and Performance of Proof of Work in Blockchains’, 2016 ACM SIGSAC conference paper], and once validated by at least one node, that group is written into a new block by that node, and the new block is distributed to all peers. This process of validation is known as ‘mining’. Some blockchain nodes are miners—but most nodes are not since mining requires a high computing power, and for their mining effort, they are paid a fee called ‘gas’. Some of the blockchain nodes are also ‘virtual machines’ that can run an executable code called ‘smart contract’, which allows integration of a business logic and process. All other nodes are simply users/accounts that generate transactions. These roles are also well known in prior art and therefore will not be recited in detail.

The so-called block in blockchain is unfortunately designed to store only a small amount of information. Therefore, blockchain is not suited to store transactions that entail large amounts of data because the cost of transmitting and storing data in blockchain is high given that the entire ledger is replicated and stored in each node. Historically, blockchain was designed for crypto currency transactions that look as simple as “Alice sends two coins to Bob”. The transaction holds only the information of the sender (Alice), the receiver (Bob), and the asset transferred. If the transaction involves large file transfers associated with the transaction, then the solution uses both blockchain and a traditional database. Blockchain is operationally slow, complex and expensive, but it brings several unique attributes of being un-tampered, trustworthy and transparent.

Embodiments of the present invention are an improvement over prior art systems and methods.

### SUMMARY OF THE INVENTION

In one embodiment, the present invention provides a a method for campaign management to directly supply services or goods to one or more beneficiaries of a campaign, the method comprising the steps of: (a) setting up, by a controller, a campaign for a needed service or good for one or more beneficiaries of the campaign, the needed service or good having an associated cost of service; (b) determining, by the controller, a plurality of criteria for picking a given service provider eligible to enter into the campaign, the given service provider offering the needed service or good, the plurality of criteria being configurable; (c) identifying, by the controller, a plurality of service providers who meet the plurality of criteria to supply the needed service or good to apply to the campaign, the plurality of service providers forming a candidate service provider pool; (d) the controller selecting the given service provider from the plurality of service providers from the candidate service provider pool via a consensus method, the consensus method being executed only by the one or more beneficiaries, the consensus method being configurable; (e) the controller collecting funds for the campaign via one or more funders, the funds covering the associated cost of service; (f) the controller terminating the campaign after collecting the funds in step (e); (g) the controller ensuring the one or more beneficiaries receive the needed good or service in its entirety from the given service provider selected in step (d); (h) upon completion of the needed good or service in its entirety by the given service provider, the controller transferring the collected funds in (e) to the given service provider selected in step (d), and wherein information associated with steps (a) through (h) are recorded on a transaction ledger, the transaction ledger accessible by the one or more funders, one or more beneficiaries, the plurality of service providers, and the controller of the campaign.

In another embodiment, the present invention provides a method for campaign management to directly supply services or goods to at least one beneficiary of a campaign, the method as implemented in the at least one beneficiary having the steps of: (a) setting up, by the at least one beneficiary, a campaign for a needed good or service for the at least one beneficiary, the needed good or service having an associated cost; (b) the at least one beneficiary determining a plurality of criteria for picking a given service provider eligible to enter into the campaign, the given service provider offering the needed service or good, the plurality of criteria being configurable; (c) the at least one beneficiary identifying a plurality of service providers who meet the plurality of criteria to supply the needed service or good to apply to the campaign, the plurality of service providers forming a candidate service provider pool; (d) collecting funds for the campaign via the one or more funders, the funds covering the associated cost of service; (e) terminating the campaign after collecting the funds in step (d); (f) the at least one beneficiary selecting the given service provider from the plurality of service providers in the candidate service provider pool via a consensus method, the consensus method being executed either by the at least one beneficiary or the at least one beneficiary and the one or more funders, the consensus method being configurable; (g) ensuring the at least one beneficiary receives the needed good or service in its entirety from the given service provider selected in step (f); (h) upon completion of the needed good or service in its entirety by the given service provider, transferring the collected funds in (d) to the given service provider selected in step (f), and wherein information associated with steps (a) through (h) are recorded in a transaction ledger, the transaction ledger accessible by the one or more funders, the at least one beneficiary, and the plurality of service providers.

In yet another embodiment, the present invention provides a system for campaign management to directly supply services or goods to one or more beneficiaries of a campaign, the system comprising: (a) a campaign generator to generate the campaign; (b) a campaign tracker to track a plurality of transactions associated with campaign execution across the one or more beneficiaries, one or more service providers and one or more funders; (c) a transaction ledger to record the plurality of transactions of the campaign tracker; (d) a digital identification generator and verifier, the digital identification generator and verifier: generating digital identities, verifying existing digital identities, or translating digital identities to actual identities; (e) a user interface enabling the one or more beneficiaries, the one or more service provider and the one or more funders access to the campaign; and (f) one or more databases that store information on service provider selection criteria, consensus methods for service provider selection, information about the one or more funders, the one or more beneficiaries, the one or more service providers and one or more campaign attributes, wherein the campaign is set up for a needed good or service for the one or more beneficiaries of the campaign, the needed service having an associated cost of service; wherein the campaign generator determining a plurality of criteria for picking a given service provider eligible to enter into the campaign, the given service provider offering the needed service or good, the plurality of criteria being configurable; wherein the campaign generator identifying a plurality of service providers who meet the plurality of criteria to supply the needed service or good to apply to the campaign, the plurality of service providers forming a candidate service provider pool; wherein the campaign generator selecting the given service provider from the plurality of service providers in the candidate service provider pool via a consensus method, the consensus method being executed only by the one or more beneficiaries, the consensus method being configurable; and wherein the campaign generator collecting funds for the campaign via one or more funders, the funds covering the associated cost of service, terminating the campaign after collecting the funds, ensuring the one or more beneficiaries receive the needed service or good in its entirety from the given service provider and, upon completion of the needed service in its entirety or providing the good by the given service provider, transferring the collected funds to the given service provider.

### BRIEF DESCRIPTION OF THE DRAWINGS

The present disclosure, in accordance with one or more various examples, is described in detail with reference to the following figures. The drawings are provided for purposes of illustration only and merely depict examples of the disclosure. These drawings are provided to facilitate the reader's understanding of the disclosure and should not be considered limiting of the breadth, scope, or applicability of the disclosure. It should be noted that for clarity and ease of illustration these drawings are not necessarily made to scale.

FIG. 1 depicts a simple diagram showing all actors according to the present invention.

FIG. 2 shows a high-level diagram showing the system of the present invention using only relational databases.

FIG. 3 shows a high-level diagram showing the system of the present invention using both blockchain and relational databases.

FIG. 4 depicts a flow-diagram showing exemplary steps of a first method of the present invention.

FIG. 5 depicts a flow-diagram showing exemplary steps of a second method of the present invention.

FIG. 6 depicts a flow-diagram showing exemplary steps of a third method of the present invention.

### DESCRIPTION OF THE PREFERRED EMBODIMENTS

While this invention is illustrated and described in a preferred embodiment, the invention may be produced in many different configurations. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein.

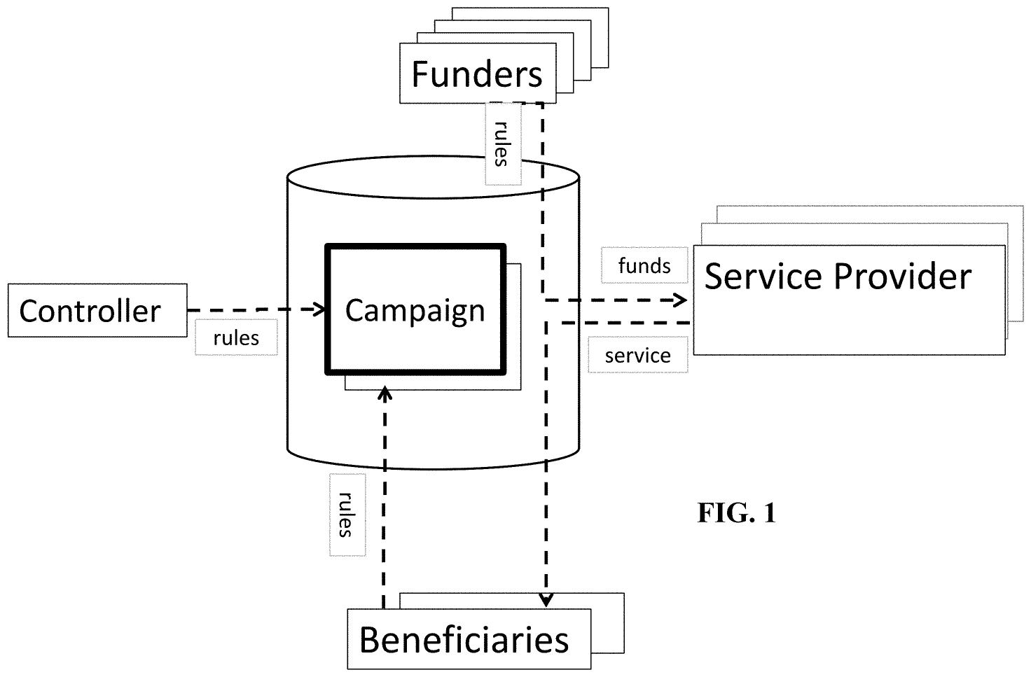

FIG. 1 illustrates the preferred relationship between all the actors in the invention. The solution architecture is in the center of the figure, which combines all other actors through a campaign stored in a database. The controller entity, beneficiaries and funders can define the ‘rules’ of the campaign (the controller entity may or may not exist depending on the embodiment of invention). The rules may include but are not limited to (i) determining the eligibility of beneficiaries, funders, and service providers, (ii) assigning or registering the digital identifications of the actors, (iii) determining the closing conditions of a campaign such as ending date and/or total amount of funding or service provider criteria, and (iv) determining the consensus method for service provider selection. A single or a plurality of beneficiaries declare their need and set the campaign. Funders query the architecture for open campaigns and can fund any open campaign they are eligible to. A single or a plurality of service providers that meet the specified criteria can apply to the campaign as a candidate. A provider is selected from the candidate pool through the chosen consensus method to deliver the needed service or good to the beneficiaries of the campaign. This process needs the verification of the actual identities of the beneficiaries and service providers (translated from their digital identifications exposed to the campaign) to execute the physical transfer of the service or good.

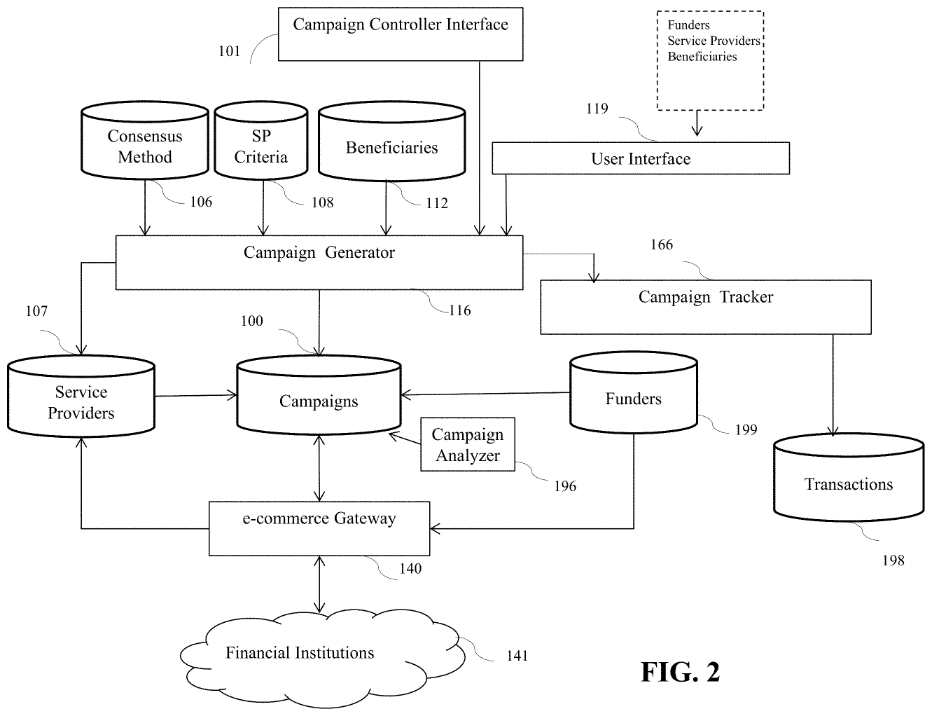

FIG. 2 shows the first embodiment of the system with the use of relational databases. Key components are illustrated. Database 100 holds the information associated with all active campaigns. Campaign Controller Interface 101 is used by the controller entity to create and manage a campaign, when a controller is used. Database 106 holds the information regarding the consensus methods for the service provider selection. Database 108 holds service provider eligibility criteria for different service and good sectors. These are various categories and corresponding values such as timeliness, quality of service, locality, experience, and cost/price. Database 112 holds the identities and needs of the beneficiaries. These databases, together with the input from the User Interface 119 from beneficiaries are fed to the Campaign Generator 116, which outputs a campaign and saves it to the campaign database 100. Database 107 holds applicant service providers' information. Through user interface 119 the funders, service providers and beneficiaries have access to the campaign.

Funders are saved to the database 199. They can fund to an open campaign through an e-commerce gateway 140 by using an appropriate payment method such as using credit cards or wire transfers. The e-commerce gateway is connected to a plurality of financial institutions 141 including but not limited to banks and factoring companies. The fund pool collected in a campaign wallet is transferred through the e-commerce gateway only after the service is provided to the beneficiary successfully, which is checked from campaign tracker 166, which tracks all steps of the campaign. It records all transactions into the transaction Database 198.

Furthermore, the system of the present invention generates a receipt for each funder and stores the receipt both in the Transactions database 198 (and/or provides the receipt to in e-mail form to the funder). The funder can later retrieve all his/her receipts from the Transactions database.

The Campaigns database holds both active as well as the completed past campaigns. For each past campaign (successfully completed or not), information such as the total amount of funds raised, total number of funders, size of requested funds, class of requested funding, completion time (if applicable), and selected provider is kept. Other subjective data such as description text attributes and number and type of media files used in the campaign announcement are also stored. Campaign analyzer 196 is a post-mortem tool that analyzes the aforementioned data using Artificial Intelligence (AI) and Machine Learning (ML) to (i) determine a success metric for each campaign to deduct the right properties for most successful campaigns, and (ii) to detect and prevent fraudulent activities such as money laundering. The deduced properties related to campaign success are given as a feedback while creating a new campaign. Furthermore, the controller and/or other actors of the system or a third party entity can be alerted about detected frauds. The fraud detector may disqualify fraudulent actors from forming or joining campaigns for good. Campaign analyzer 196 is a post-mortem tool that analyzes the aforementioned data using Artificial Intelligence (AI) and Machine Learning (ML) to determine a success metric for each campaign to deduce the right properties for most successful campaigns. These properties may be given as a feedback while creating a new campaign.

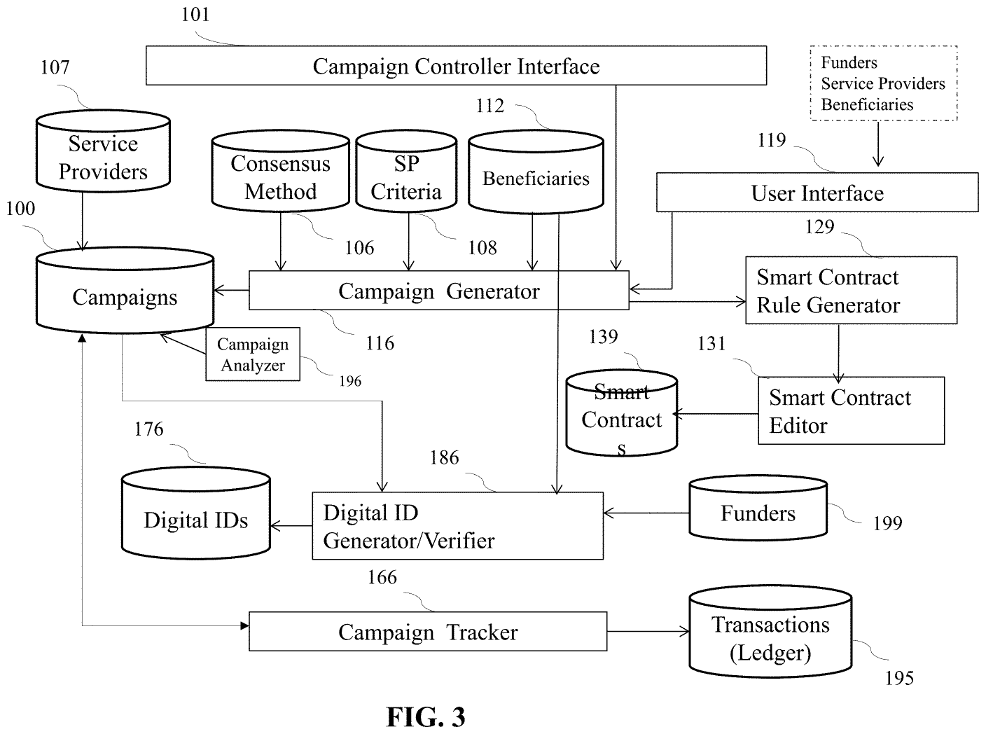

FIG. 3 shows the second embodiment of the system with blockchain and databases. Many components are the same as the system of FIG. 2. Therefore, their function will not be recited again. Instead, the new components pertinent to the blockchain implementation will be detailed. Campaign tracker 166 keeps track of all transactions in relation to each campaign, wherein all transactions that are digitally signed by the transaction initiator are saved to ledger 195, which is implemented as a blockchain using an open source or commercial blockchain platform.

Digital ID generator/verifier 186 either generates a digital identity for an actor of the system, and/or verifies the digital identity if the actor uses a digital identity generated by another system. Additionally, digital ID generator/verifier 186 translates digital identities back into actual identities of the beneficiaries and funders for service execution and funding. The transactions that appear on blockchain use the digital identities and digital signatures of the actors for anonymity. The transaction ledger provides complete transparency since all actors can see the transactions on the system of the present invention.

The output of campaign generator 116 is sent to smart contract rule generator 129 that translates the critical campaign parameters into proper rules that can be programmed into a smart contract of blockchain. The rules are sent to the smart contract editor 131 so that it can generate the software code of the new smart contract, or simply modify an existing smart contract code. The resulting smart contract is then saved in smart contracts database 139. All these steps of smart contract generation are automated without needing any manual intervention. Each campaign will have at least one associated smart contract.

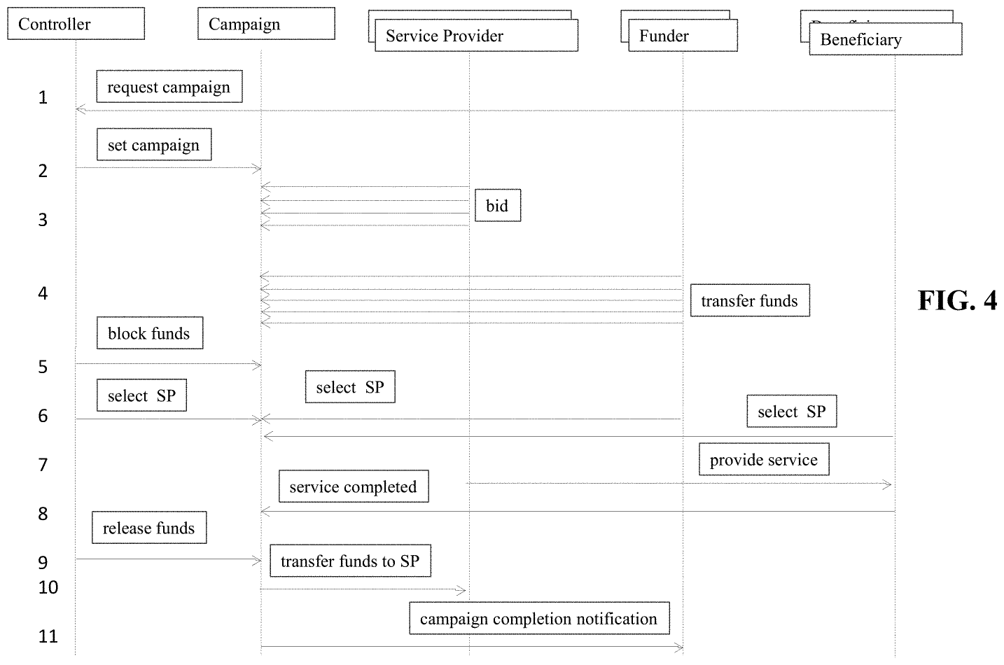

FIG. 4 shows a flow-diagram of exemplary steps of a first method of the present invention. In this method, a single or a plurality of beneficiaries request a campaign for their specific need, from the controller in step 1. In turn, the controller verifies the beneficiaries and their needs, and sets the campaign in step 2. A plurality of service providers eligible to the campaign then bid in step 3. Upon completion of the bidding period or while the bidding is in progress (depending on the chosen method), the funders fund the campaign in step 4. Funds are initially blocked in step 5 until the service provider is selected in step 6 by the controller entity, beneficiaries and the funders collectively. A consensus mechanism agreed during campaign formation is used to select the service provider. The selected service provider provides the need in step 7. After the completion of the service in step 8 (the provider and possibly beneficiaries declare the completion of the service), the funds are released in step 9, and transferred to the service provider in step 10. All actors are notified that the campaign is successfully completed in step 11. During all these transactions, each step will appear as a transaction on the blockchain wherein the actors will be represented by their digital identities.

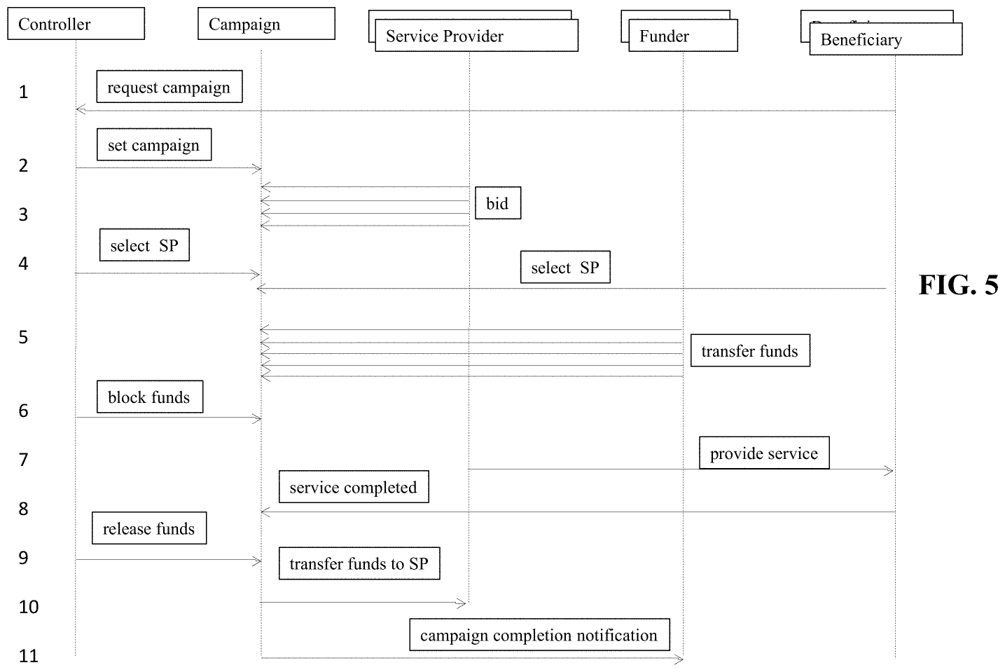

FIG. 5 shows a flow-diagram of exemplary steps of a second method of the present invention. In this method, a single or a plurality of beneficiaries request a campaign for their specific need, from the controller in step 1. In turn, the controller verifies the beneficiaries and their needs and sets the campaign in step 2. A plurality of service providers eligible to the campaign then bid in step 3. Once the bidding period ends, the service provider is selected in step 4 by the beneficiaries and the controller (funders are not known yet). A consensus mechanism agreed during campaign formation is used. The funders fund the campaign in step 5 (at this stage, the service provider and required funds are known by the funders). Funds are initially blocked in step 6 until the service provider that is selected in step 4 provides the service. The selected service provider provides the need in step 7. After the completion of the service in step 8 (the provider and possibly beneficiaries declare the completion of the service), the funds are released in step 9, and transferred to the service provider in step 10. All actors are notified that the campaign is successfully completed in step 11. During all these transactions, each step will appear as a transaction on the blockchain wherein the actors will be represented by their digital identities.

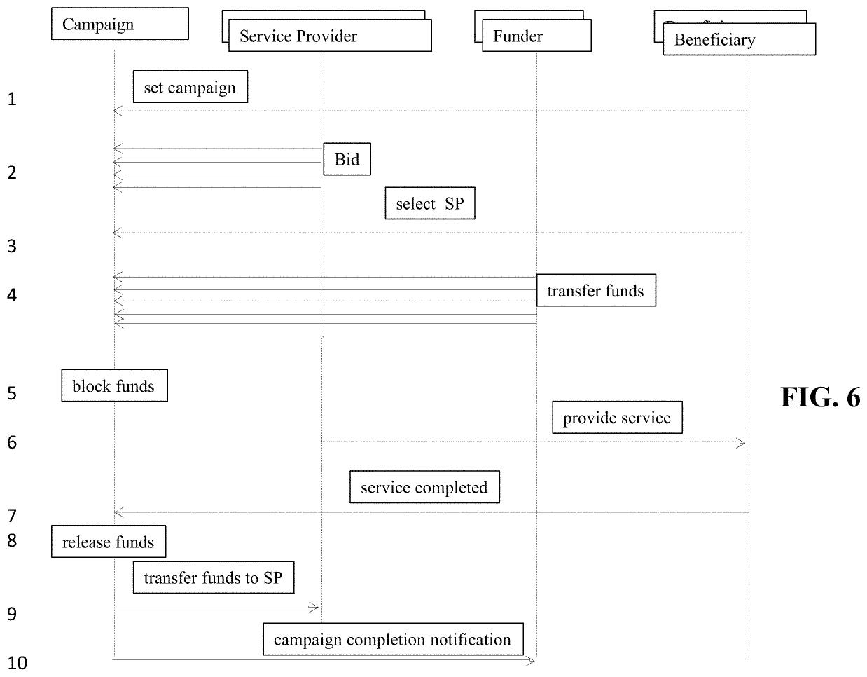

FIG. 6 shows a flow-diagram of exemplary steps of a third method of the present invention. In this method, a single or a plurality of beneficiaries generate the campaign for their specific needs in step 1 without using a controller. A plurality of service providers eligible to the campaign then bid in step 2. Once the bidding period ends, the service provider is selected in step 3 by the beneficiaries using a consensus method. The funders fund the campaign in step 4 (at this stage, the service provider and required funds are known by the funders). Funds are initially blocked in step 5 until the service provider that is selected in step 3 provides the service. The selected service provider provides the need in step 6. After the completion of the service in step 7 (the provider and possibly beneficiaries declare the completion of the service), the funds are released in step 8, and transferred to the service provider in step 9. All actors are notified that the campaign is successfully completed in step 10. During all these transactions, each step will appear as a transaction on the blockchain wherein the actors will be represented by their digital identities.

It should be noted that in the figures and examples described herein, while it is noted that the entirety of the funds are released to the selected service provider upon completion of the needed service in its entirety or providing the good, it is also envisioned in a separate embodiment that a portion of the collected funds may be released to the selected service provider, with the remainder of the collected funds released to the selected service provider upon completion of the needed service in its entirety or providing the good.

It should be noted that while the disclosure specifies service providers, it is understood that such service providers may supply both services or goods.

In one embodiment, the present invention provides a method for campaign management to directly supply services or goods to one or more beneficiaries of a campaign, the method comprising the steps of: (a) setting up, by a controller, a campaign by the controller for a needed service or good for one or more beneficiaries of the campaign, the needed service or good having an associated cost of service; (b) determining, by the controller, a plurality of criteria for picking a given service provider eligible to enter into the campaign, the given service provider offering the needed service or good, the plurality of criteria being configurable; (c) identifying, by the controller, a plurality of service providers who meet the plurality of criteria to supply the needed service or good to apply to the campaign, the plurality of service providers forming a candidate service provider pool; (d) the controller selecting the given service provider from the plurality of service providers in the candidate service provider pool via a consensus method, the consensus method being executed only by the one or more beneficiaries, the consensus method being configurable; (e) the controller collecting funds for the campaign via one or more funders, the funds covering the associated cost of service; (f) the controller terminating the campaign after collecting the funds in step (e); (g) the controller ensuring the one or more beneficiaries receive the needed good or service in its entirety from the given service provider selected in step (d); (h) upon completion of the needed service in its entirety by the given service provider or of the providing of the good, the controller transferring the collected funds in (e) to the given service provider selected in step (d), and wherein information associated with steps (a) through (h) are recorded on a transaction ledger, the transaction ledger accessible by the one or more funders, one or more beneficiaries, the plurality of service providers, and the controller of the campaign.

In another embodiment, the present invention provides a method for campaign management to directly supply services or goods to at least one beneficiary of a campaign, the method as implemented in the at least one beneficiary having the steps of: (a) setting up, by the at least one beneficiary, a campaign for a needed service or good for the at least one beneficiary, the needed service or good having an associated cost of service; (b) the at least one beneficiary determining a plurality of criteria for picking a given service provider eligible to enter into the campaign, the given service provider offering the needed service or good, the plurality of criteria being configurable; (c) the at least one beneficiary identifying a plurality of service providers who meet the plurality of criteria to supply the needed service or good to apply to the campaign, the plurality of service providers forming a candidate service provider pool; (d) collecting funds for the campaign via the one or more funders, the funds covering the associated cost of service; (e) terminating the campaign after collecting the funds in step (d); (f) the at least one beneficiary selecting the given service provider from the plurality of service providers in the candidate service provider pool via a consensus method, the consensus method being executed either by the at least one beneficiary or the at least one beneficiary and the one or more funders, the consensus method being configurable; (g) ensuring the at least one beneficiary receives the needed good or service in its entirety from the given service provider selected in step (f); (h) upon completion of the delivery of needed good or service in its entirety by the given service provider, transferring the collected funds in (d) to the given service provider selected in step (f), and wherein information associated with steps (a) through (h) are recorded in a transaction ledger, the transaction ledger accessible by the one or more funders, the at least one beneficiary, and the plurality of service providers.

In yet another embodiment, the present invention provides a system for campaign management to directly supply services or goods to one or more beneficiaries of a campaign, the system comprising: (a) a campaign generator to generate the campaign; (b) a campaign tracker to tracks a plurality of transactions associated with campaign execution across the one or more beneficiaries, one or more service providers and one or more funders; (c) a transaction ledger to record the plurality of transactions of the campaign tracker; (d) a digital identification generator and verifier, the digital identification generator and verifier: generating digital identities, verifying existing digital identities, or translating digital identities to actual identities; (e) a user interface enabling the one or more beneficiaries, the one or more service provider and the one or more funders access to the campaign; and (f) one or more databases that store information on service provider selection criteria, consensus methods for service provider selection, information about the one or more funders, the one or more beneficiaries, the one or more service providers and one or more campaign attributes, wherein the campaign is set up for a needed service or good for the one or more beneficiaries of the campaign, the needed service or good having an associated cost; wherein the campaign generator determining a plurality of criteria for picking a given service provider eligible to enter into the campaign, the given service provider offering the needed good or service, the plurality of criteria being configurable; wherein the campaign generator identifying a plurality of service providers who meet the plurality of criteria to supply the needed good or service to apply to the campaign, the plurality of service providers forming a candidate service provider pool; wherein the campaign generator selecting the given service provider from the plurality of service providers in the candidate service provider pool via a consensus method, the consensus method being executed only by the one or more beneficiaries, the consensus method being configurable; and wherein the campaign generator collecting funds for the campaign via one or more funders, the funds covering the associated cost of service, terminating the campaign after collecting the funds, ensuring the one or more beneficiaries receive the needed good or service in its entirety from the given service provider and, upon completion of the needed good or service in its entirety by the given service provider, transferring the collected funds to the given service provider.

The above-described features and applications can be implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor. By way of example, and not limitation, such non-transitory computer-readable media can include flash memory, RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. The computer readable media does not include carrier waves and electronic signals passing wirelessly or over wired connections.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

In this specification, the term “software” is meant to include firmware residing in read-only memory or applications stored in magnetic storage or flash storage, for example, a solid-state drive, which can be read into memory for processing by a processor. Also, in some implementations, multiple software technologies can be implemented as sub-parts of a larger program while remaining distinct software technologies. In some implementations, multiple software technologies can also be implemented as separate programs. Finally, any combination of separate programs that together implement a software technology described here is within the scope of the subject technology. In some implementations, the software programs, when installed to operate on one or more electronic systems, define one or more specific machine implementations that execute and perform the operations of the software programs.

A computer program (also known as a program, software, software application, to script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, for example microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable BluRay® discs, ultra density optical discs, any other optical or magnetic media, and floppy disks. The computer-readable media can store a computer program that is executable by at least one processing unit and includes sets of instructions for performing various operations. Examples of computer programs or computer code include machine code, for example is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example application specific integrated circuits (ASICs) or field programmable gate arrays (FPGAs). In some implementations, such integrated circuits execute instructions that are stored on the circuit itself.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components illustrated above should not be understood as requiring such separation, and it should be understood that the described program components and systems can generally be integrated together in a single software product or packaged into multiple software products.

Various modifications to these aspects will be readily apparent, and the generic principles defined herein may be applied to other aspects. Thus, the claims are not intended to be limited to the aspects shown herein, but is to be accorded the full scope consistent with the language claims, where reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject technology.

A phrase, for example, an “aspect” does not imply that the aspect is essential to the subject technology or that the aspect applies to all configurations of the subject technology. A disclosure relating to an aspect may apply to all configurations, or one or more configurations. A phrase, for example, an aspect may refer to one or more aspects and vice versa. A phrase, for example, a “configuration” does not imply that such configuration is essential to the subject technology or that such configuration applies to all configurations of the subject technology. A disclosure relating to a configuration may apply to all configurations, or one or more configurations. A phrase, for example, a configuration may refer to one or more configurations and vice versa.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

While this specification contains many specific implementation details, these should not be construed as limitations on the scope of any invention or of what may be to claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

As noted above, particular embodiments of the subject matter have been described, but other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

### CONCLUSION

A system and method have been shown in the above embodiments for the effective implementation of an apparatus and method for delivery of crowdfunded services and goods. While various preferred embodiments have been shown and described, it will be understood that there is no intent to limit the invention by such disclosure, but rather, it is intended to cover all modifications falling within the spirit and scope of the invention, as defined in the appended claims.

1. A method for campaign management to directly supply services or goods to one or more beneficiaries of a campaign, the method comprising the steps of:
(a) setting up, by a controller, a campaign for a needed service or good for one or more beneficiaries of the campaign, the needed service or good having an associated cost of service;
(b) determining, by the controller, a plurality of criteria for picking a given service provider eligible to enter into the campaign, the given service provider offering the needed service or good, the plurality of criteria being configurable;
(c) identifying, by the controller, a plurality of service providers who meet the plurality of criteria to supply the needed service or good to apply to the campaign, the plurality of service providers forming a candidate service provider pool;
(d) the controller selecting the given service provider from the plurality of service providers from the candidate service provider pool via a consensus method, the consensus method being executed only by the one or more beneficiaries, the consensus method being configurable;
(e) the controller collecting funds for the campaign via one or more funders, the funds covering the associated cost of service;
(f) the controller terminating the campaign after collecting the funds in step (e);
(g) the controller ensuring the one or more beneficiaries receive the needed good or service in its entirety from the given service provider selected in step (d);
(h) upon completion of the needed good or service in its entirety by the given service provider, the controller transferring the collected funds in (e) to the given service provider selected in step (d), and
wherein information associated with steps (a) through (h) are recorded on a transaction ledger, the transaction ledger accessible by the one or more funders, one or more beneficiaries, the plurality of service providers, and the controller of the campaign.

2. The method of claim 1, wherein the plurality of criteria comprises a plurality of the following: cost, timeliness, quality, locality, experience, and expertise.

3. The method of claim 1, wherein the consensus method comprises any of the following: reverse auction, voting, and weighted criteria.

4. The method of claim 3, wherein voting comprises any of the following: one vote for one person, voting based on a linear method, and voting based on a quadratic method.

5. The method of claim 1, wherein the consensus method is executed by any of, or a combination of, the following: the controller, the one or more beneficiaries, and the one or more funders.

6. The method of claim 1, wherein funds collected in (e) are any of the following: crypto currency or actual currency.

7. The method of claim 1, wherein the one or more beneficiaries and the one or more funders are authenticated to participate in the campaign using digital identities or actual identities.

8. A method for campaign management to directly supply services or goods to at least one beneficiary of a campaign, the method as implemented in the at least one beneficiary having the steps of:
(a) setting up, by the at least one beneficiary, a campaign for a needed good or service for the at least one beneficiary, the needed good or service having an associated cost;
(b) the at least one beneficiary determining a plurality of criteria for picking a given service provider eligible to enter into the campaign, the given service provider offering the needed service or good, the plurality of criteria being configurable;
(c) the at least one beneficiary identifying a plurality of service providers who meet the plurality of criteria to supply the needed service or good to apply to the campaign, the plurality of service providers forming a candidate service provider pool;
(d) collecting funds for the campaign via the one or more funders, the funds covering the associated cost of service;
(e) terminating the campaign after collecting the funds in step (d);
(f) the at least one beneficiary selecting the given service provider from the plurality of service providers in the candidate service provider pool via a consensus method, the consensus method being executed either by the at least one beneficiary or the at least one beneficiary and the one or more funders, the consensus method being configurable;
(g) ensuring the at least one beneficiary receives the needed good or service in its entirety from the given service provider selected in step (f);
(h) upon completion of the needed good or service in its entirety by the given service provider, transferring the collected funds in (d) to the given service provider selected in step (f), and
wherein information associated with steps (a) through (h) are recorded in a transaction ledger, the transaction ledger accessible by the one or more funders, the at least one beneficiary, and the plurality of service providers.

9. The method of claim 8, wherein the plurality of criteria comprises a plurality of the following: cost, timeliness, quality, locality, experience, and expertise.

10. The method of claim 8, wherein the consensus method comprises any of the following: reverse auction, voting, and weighted criteria.

11. The method of claim 10, wherein voting comprises any of the following: one vote for one person, voting based on a linear method, and voting based on a quadratic method.

12. The method of claim 8, wherein funds collected in (e) are any of the following: crypto currency or actual currency.

13. The method of claim 8, wherein the at least one beneficiary and the one or more funders are authenticated to participate in the campaign using digital identities or actual identities.

14. A system for campaign management to directly supply services or goods to one or more beneficiaries of a campaign, the system comprising:
(a) a campaign generator to generate the campaign;
(b) a campaign tracker to track a plurality of transactions associated with campaign execution across the one or more beneficiaries, one or more service providers and one or more funders;
(c) a transaction ledger to record the plurality of transactions of the campaign tracker;
(d) a digital identification generator and verifier, the digital identification generator and verifier: generating digital identities, verifying existing digital identities, or translating digital identities to actual identities;
(e) a user interface enabling the one or more beneficiaries, the one or more service provider and the one or more funders access to the campaign; and
(f) one or more databases that store information on service provider selection criteria, consensus methods for service provider selection, information about the one or more funders, the one or more beneficiaries, the one or more service providers and one or more campaign attributes,
wherein the campaign is set up for a needed good or service for the one or more beneficiaries of the campaign, the needed service having an associated cost of service;
wherein the campaign generator determining a plurality of criteria for picking a given service provider eligible to enter into the campaign, the given service provider offering the needed service or good, the plurality of criteria being configurable;
wherein the campaign generator identifying a plurality of service providers who meet the plurality of criteria to supply the needed service or good to apply to the campaign, the plurality of service providers forming a candidate service provider pool;
wherein the campaign generator selecting the given service provider from the plurality of service providers in the candidate service provider pool via a consensus method, the consensus method being executed only by the one or more beneficiaries, the consensus method being configurable; and
wherein the campaign generator collecting funds for the campaign via one or more funders, the funds covering the associated cost of service, terminating the campaign after collecting the funds, ensuring the one or more beneficiaries receive the needed service or good in its entirety from the given service provider and, upon completion of the needed service in its entirety or providing the good by the given service provider, transferring the collected funds to the given service provider.

15. The system of claim 14, wherein the system further comprises a smart contract rule generator, a smart contract editor and smart contract database to generate and store a smart contract of each campaign.

16. The system of claim 14, wherein the transaction ledger is a database or a blockchain.

17. The system of claim 14, wherein the system verifies digital identities by connecting to an external system by using a verification API.

18. The system of claim 14, wherein the user interface is any of the following: a web application, a downloadable application for a computer, or a downloadable application for a smart phone.

19. The system of claim 14, wherein the system further comprises a campaign analyzer to analyze completed campaigns either for determining one or more campaign success factors or for detecting fraudulent activities.

20. The system of claim 14, wherein the plurality of criteria comprises a plurality of the following: cost, timeliness, quality, locality, experience, and expertise.
